(19) United States
(12) Patent Application Publication
(10) Pub. No.: US 2008/0313046 A1
(43) Pub. Date: Dec. 18, 2008

(54) FOOD ORDERING SYSTEM AND METHOD

(76) Inventors: Igor Denenburg, Beberi (LV); Henry Kastelyanets, Woodbridge (CA); Michael Polyakin, London (CA)

Correspondence Address: PERKINS COIE LLP;PATENT-SEA, P.O. BOX 1247, SEATTLE, WA, 98111-1247, US

(21) Appl. No.: 12/139,432

(22) Filed: Jun. 13, 2008

Related U.S. Application Data
(60) Provisional application No. 60/929,147, filed on Jun. 15, 2007.

(51) Int. Cl. G06Q 50/00

(52) U.S. Cl. 705/15; 186/38; 705/16; 186/39

(57) ABSTRACT

Embodiments of a food ordering system include a menu board station adapted to display information about a plurality of food items. At least one dispenser is associated with at least one of the plurality of food items. The at least one dispenser is adapted to dispense an article including identifying data corresponding to one of the plurality of food items. An article receiving station is adapted to receive the article and identify the identifying data on the article. Other embodiments of a food ordering system include a menu board station displaying information about a plurality of food items. The information includes at least one identifier associated with each food item. An ordering panel is proximate to the menu board station and includes a user interface for placing an order by inputting one or more of the identifiers. A kitchen interface is operably linked to the ordering panel for receiving the order.

### CROSS REFERENCE TO RELATED APPLICATIONS

This application claims priority from U.S. Provisional Patent Application 60/929,147, filed on Jun. 15, 2007, which is incorporated herein by reference in its entirety.

### FIELD

Embodiments of the disclosure relate to a method and system for ordering food items. More specifically, embodiments of the disclosure relate to a system and method for ordering food items at fast food restaurants.

### BACKGROUND

In typical fast food restaurants, a user places an order by lining up while simultaneously reading a menu, and then verbally conveying an order to a cashier. The cashier enters the order into the restaurant's food preparation system to begin the preparation of the food item(s) ordered, and collects payment for the order from the consumer.

### SUMMARY

In typical fast food restaurants, once a consumer is standing in the line at a fast food restaurant to place an order, he/she may not have enough time to comfortably compose or adjust his/her order as the consumer approaches the cashier. The consumers queued behind the ordering consumer may cause the consumer to feel pressure to quickly place his/her order, pay for his/her order, and get out of the way to enable the next consumer to make their order. This may cause consumers to feel uncomfortable or rushed when ordering their food items or paying for their order.

Confusion, misunderstanding of the menu and discomfort of the consumer can also cause delays for the restaurant operator. The delay may have a significant effect on the commercial success of the restaurant, particularly for restaurants whose commercial viability depends on providing fast service. In addition, consumers who had an unpleasant experience when ordering at a restaurant may not return to that restaurant.

Processing and dispensing a food order using the method described above also requires the fast food restaurant to maintain a larger staff. This can increase the costs of operation of the restaurant. In addition, because consumers may be confused or have difficulty seeing the menu, the restaurant may be required to devote greater amounts of space to the menu observation and ordering area of the restaurant. The extra space requirement may, in turn, reduce the ability of the restaurant to efficiently allocate space to other uses, such as seating or food preparation.

Embodiments of the present disclosure provide a food ordering system and method which may provide enough time to a consumer to comfortably compose or adjust and place his/her order. In some embodiments, the order may be placed before approaching a cashier. Accordingly, the user may not feel pressure to quickly place his/her order, pay for his/her order, and get out of the way to enable the next consumer to make their order.

Additionally, embodiments of the present disclosure may reduce or minimize delays for the restaurant operator. The reduced delay may have a significant effect on the commercial success of the restaurant, particularly for restaurants whose commercial viability depends on providing fast service.

According to a first broad aspect, a food ordering system is provided. Embodiments of this broad aspect include a menu board station adapted to display information about a plurality of food items. At least one dispenser is associated with at least one of the plurality of food items. The at least one dispenser is adapted to dispense an article including identifying data corresponding to one of the plurality of food items. An article receiving station is adapted to receive the article and identify the identifying data on the article.

In some embodiments, the article is one of a token or a ticket. In embodiments wherein the article is a ticket, the ticket may include at least one flap, which is associated with a predetermined property for the food item. The flap is movable between a folded configuration and an unfolded configuration. The folded configuration is associated with one of a desired presence or a desired absence of the predetermined property for the food item, and the unfolded configuration is associated with the other of the desired presence or desired absence of the predetermined property for the food item. The article receiving station may be adapted to identify the predetermined property and configuration associated with each flap.

In some embodiments, the predetermined property may be a condiment, and the folded configuration may be associated with the desired absence of the condiment.

In some embodiments, the article dispenser further includes a status indicator adapted to toggle between an active condition and an inactive condition, wherein the status indicator is adapted to communicate an inactive condition when the article dispenser is prevented from dispensing articles. The status indicator may be controlled by one or more of remotely and by a wireless device.

In some embodiments, the identifying data includes a price of the corresponding food item.

In some embodiments, the article receiving station calculates a total price when a plurality of articles are received by the article receiving station and displays the total price.

In some embodiments, the token receiving station is operably linked to a kitchen display interface, and the token receiving station transmits the identifying data to the kitchen display interface.

In some embodiments, the information displayed on the menu station includes one or more of a picture representation of a food item, a textual description of a food item, and embossed Braille text describing the food item.

In some embodiments, the identifying data identified by the token receiving station is stored.

In some embodiments, the information displayed on the menu board station can be one or more of selectively altered, selectively altered remotely, and selectively altered remotely by a wireless device.

In some embodiments, the identifying data of the token includes one or more of a picture representation of a food item, and a textual description of a food item.

In some embodiments, the identifying data is stored on the token via a plurality of holes formed in the token, and the holes are readable by the token receiving station.

In some embodiments, the menu board station displays information about a plurality of food items. The food items are classified into a plurality of food item groups, and the articles are classified into groups corresponding to the food item groups.

According to another broad aspect, a method of ordering a food item is provided. Embodiments of the method include (a) selecting a food item associated with one of a plurality of food items displayed on a menu board station; (b) receiving an article associated with the food item from an article dispenser; and (c) placing the article in an article receiving station to place an order.

In some embodiments, the method further includes (d) identifying each of the food items in the order from the article associated therewith.

In some embodiments, the method further includes calculating a price of the order. The price of the order can be displayed on a display proximate to the article receiving station.

In some embodiments, the method further includes confirming the order and/or paying for the order.

In some embodiments, the method further includes selecting a second food item from the menu board and receiving a second article associated with the second food item. The first and second articles may be placed in the article receiving station to place the order.

According to another broad aspect, a food ordering system is provided. Embodiments of the food ordering system include a menu board station displaying information about a plurality of food items. The information includes at least one identifier associated with each food item. An ordering panel is proximate to the menu board station and includes a user interface for placing an order by inputting one or more of the identifiers. A kitchen interface is operably linked to the ordering panel for receiving the order.

In some embodiments, the at least one identifier includes a number associated with each food item.

In some embodiments, the ordering panel includes a display configured to display one or more of a name of each ordered food item, a cost of each ordered food item, and a total cost of the order.

In some embodiments, the ordering panel is wirelessly linked to the kitchen display interface.

In some embodiments, the information further includes one or more of a photo of each food item, name of each food item, and a description of each food item.

In some embodiments, the information displayed on the menu board can be selectively altered or selectively altered remotely.

In some embodiments, the food ordering system further includes a paying station proximate to the ordering panel. The paying station may be integral with the ordering panel.

In some embodiments, the ordering panel includes a touch screen and/or a keypad.

According to another broad aspect, a ticket for a food ordering system is provided. The ticket includes at least one flap, and the flap is associated with a predetermined property for a food item. The flap is movable between a folded configuration and an unfolded configuration. The folded configuration is associated with one of a desired presence or a desired absence of the predetermined property for the food item, and the unfolded configuration is associated with the other of the desired presence and desired absence of the predetermined property for the food item.

In some embodiments, the predetermined property is a condiment, and the folded configuration is associated with the desired absence of the condiment.

In some embodiments, the predetermined property associated with the flap and the configuration of the flap is machine readable.

### BRIEF DESCRIPTION OF THE DRAWINGS

For a better understanding of the present disclosure and to show more clearly how it may be carried into effect, reference will now be made to the accompanying drawings that show some embodiments of the present disclosure.

FIG. 1A is a perspective view of an embodiment of the menu board station in accordance with the present disclosure;

FIG. 1B is a front plan view of the menu board of FIG. 1A;

FIG. 1C is a perspective view of an embodiment of an article receiving station in accordance with the present disclosure;

FIG. 2A is a partial perspective view of an embodiment of a series of article dispensers in accordance with the present disclosure, wherein the article dispensers are token dispensers;

FIG. 2B is a perspective view of an alternate embodiment of an article dispenser of the present disclosure with a cover of the dispenser removed, wherein the article dispenser is a ticket dispenser, and wherein the article dispenser is in the rest position;

FIG. 2C is a perspective view of the article dispenser of FIG. 2B, showing the article dispenser in the activated position;

FIG. 3A is a plan view of an embodiment of a token in accordance with the present disclosure;

FIG. 3B is an elevation view of the token illustrated in FIG. 3A;

FIG. 4A is a plan view of an alternate embodiment of a token in accordance with the present disclosure;

FIG. 4B is an elevation view of the token illustrated in FIG. 4A;

FIG. 5A is a front plan view of an embodiment of a ticket in accordance with the present disclosure;

FIG. 5B is a rear plan view of the ticket shown in FIG. 5A;

FIG. 6 is a block diagram schematically showing an embodiment of a token receiving station coupled to a kitchen display interface and a paying station;

FIG. 7 is a flow chart of an embodiment of a method of ordering a food item in accordance with the present disclosure;

FIG. 8 is a partial front plan view of a food ordering system in accordance with an embodiment of the present disclosure, showing a menu board, ordering panel, and vehicle;

FIG. 9 is a front plan view of the menu board of FIG. 8;

FIG. 10 is a front plan view of the ordering panel of FIG. 8; and

FIG. 11 is a flow chart of an alternate embodiment of a method of ordering a food item in accordance with the present disclosure.

For simplicity and clarity of illustration, elements shown in the figures have not necessarily been drawn to scale. Further, where considered appropriate, reference numerals may be repeated among the figures to indicate corresponding or analogous elements.

### DETAILED DESCRIPTION

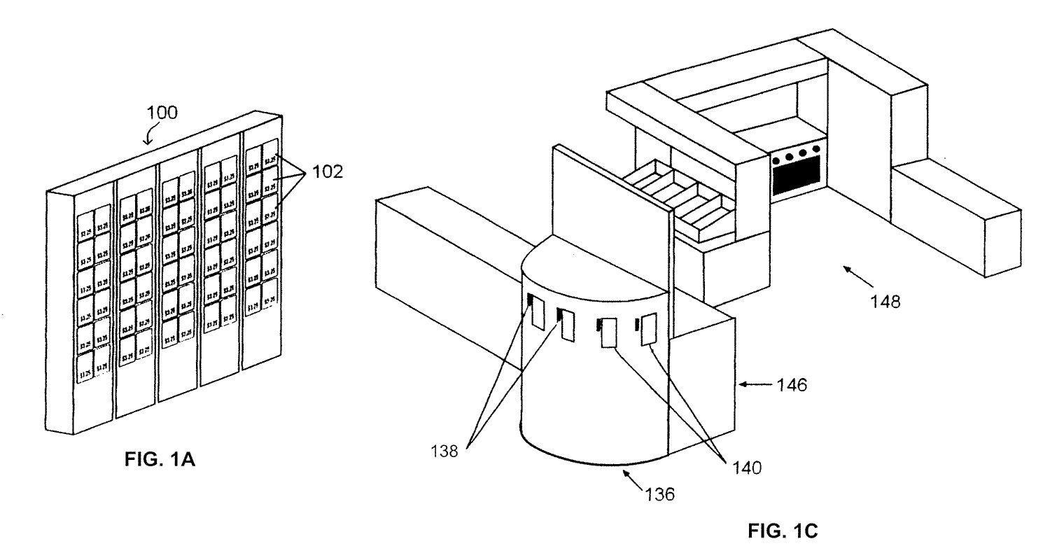

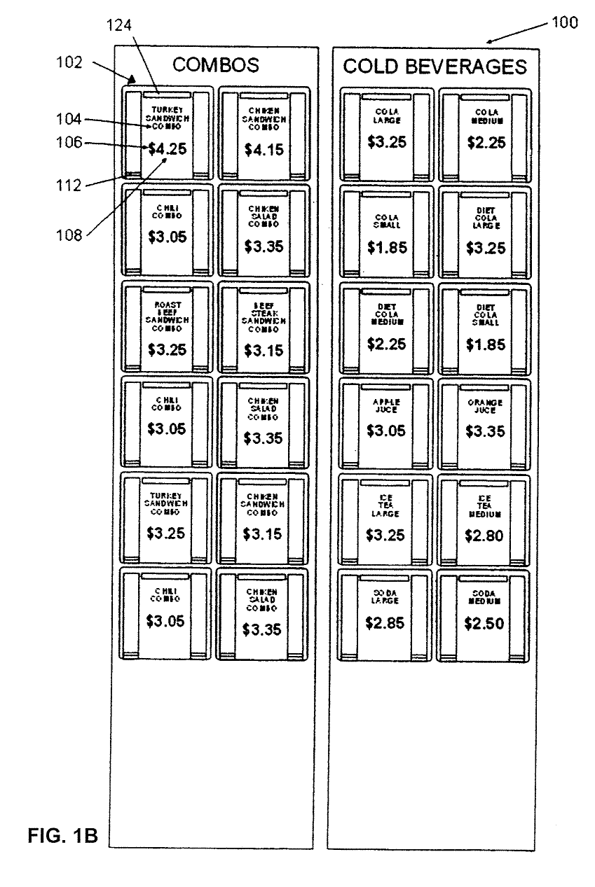

A food ordering system and method according to a first embodiment of the present disclosure is described herein with reference to FIGS. 1-7. It will be understood by those skilled in the art that the embodiments described herein may also be applied to ordering any other type of item and, accordingly, is not limited to the ordering of food items.

Referring to FIGS. 1A-1C, the food ordering system may include a menu board station 100, a plurality of article dispensers 102, and an article receiving system 136.

Referring to FIGS. 1A and 1B, an embodiment of a menu board station 100 is shown. The menu board station 100 is adapted to display information about a plurality of food items. In one embodiment, the menu board station 100 includes a number of article dispensers 102. Each article dispenser 102 corresponds to a food item or a combination of food items. Each article dispenser preferably displays information about the food item or combination associated with the article dispenser 102. In other embodiments, the information about the food items may be displayed anywhere on the menu board station 100, so as to be visible to a consumer. For example, the menu board station 100 may be a menu as seen in a typical fast food restaurant.

The food items or combinations for which information is displayed on the menu board station 100 may be any type of food item. Some example food items include typical fast food items such as beverages including cola, juices or iced tea, or sandwiches including turkey, chicken, or hamburger. The menu board station 100 may also display information for non-fast food items such as steak, potatoes, and vegetables, etc.

The information displayed on the menu board station 100 may include a text description 104 of the food item. For example, listing a cold beverage as “cola large,” or a sandwich as “turkey sandwich,” etc. In other embodiments, the information displayed about a food item on the menu board station 100 may include a picture representation of the food item. For example, a picture of a cup of cola or a picture of a representative turkey sandwich, etc. The text description 104, or the picture representation (not shown), may be of increased size to allow a person with poor eyesight to read and understand the displayed information. In addition, the menu board station 100 may also display a price 106 of the food item. The price 106 displayed may be in any currency. In addition, the price 106 displayed may include a price before tax of the food item, as well as the total price of the food item, including taxes and other applicable charges. The information displayed on the menu board station 100 may also include embossed Braille text (not shown). The Braille text can facilitate a visually impaired person's understanding of the information displayed on the menu board station 100 because of the tactile interaction with the displayed information on the menu board station 100.

The information displayed about food items on the menu board station 100 may also be selectively altered. For example, the information displayed on the menu board station 100 may include a laminated insert (not shown) that is placed into a matched pocket (not shown) on the menu board station 100. The store operator may therefore selectively alter the information displayed on the menu board station 100 by substituting a new laminated insert into the matched pocket on the menu board station 100.

In other embodiments, the information displayed on the menu board station 100 can be selectively altered remotely. For example, the menu board station 100 may include a display (not shown) such as an LCD, LED, or any other sort of electronic display upon which the information is shown. The restaurant operator could therefore selectively alter the information being displayed on the display of the menu board station 100. For example, a keyboard or keypad may be operably linked to the menu board station 100 via a computing device. The restaurant operator may select the information to be shown on the display from a database of pre-stored information, or may enter customized information to be shown on the display on the menu board station 100.

In some embodiments, a restaurant operator may interact with the computing device to alter the information displayed on the menu board station 100. The computing device may be a personal computer, laptop, personal data assistant, cellular telephone or any type of computing device. The display of the menu board station 100 may communicate with the computing device using any suitable wired or wireless communication protocols.

As discussed above, the menu board station 100 can display information about a single food item, or it may display information about a plurality of food items. The menu board station 100 may classify the plurality of food items into pluralities of food item groups. For example, cold beverages may be displayed adjacent to each other on one portion of the menu board station 100, and sandwiches or combos may be displayed adjacent to each other on another portion of the menu board station 100. The classification of the plurality of food items into pluralities of food item groups can be done according to any suitable grouping. The plurality of food items may be classified into food item groups based on the type of food item, for example, grouping drinks together, sandwiches together or desserts together. The food item groups may also be classified by price, for example, below two dollars, etc.

In other embodiments, the food items may be grouped together as combinations (also referred to as “combo” in FIG. 1). In some examples, the combinations may include a plurality of the food item groups grouped together. For example, a turkey sandwich, a cola beverage and an order of fries may be grouped together into a combination.

In other embodiments, the food ordering system may be designed to have a special menu board station 100 for children. This menu board station 100 may have a lower height to allow children to interact directly with the article dispensers 102 associated with the children menu board station 100. In addition, the menu board station 100 may have special graphics or shapes applied to it in order to allow children to more easily interact with the children menu board station 100 without any help from their parents. The children can therefore collect their own articles 110 for the food items of their choice without any help from their parents.

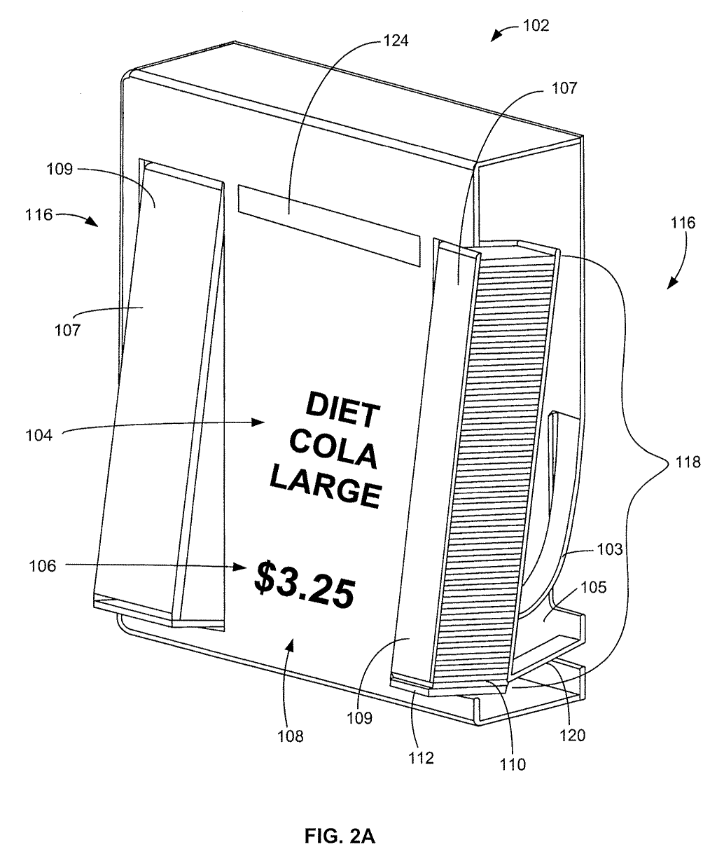

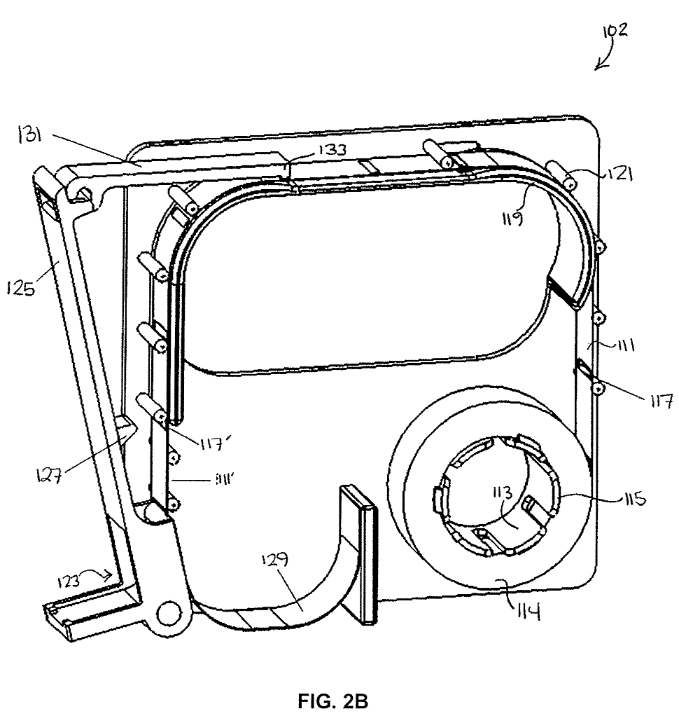

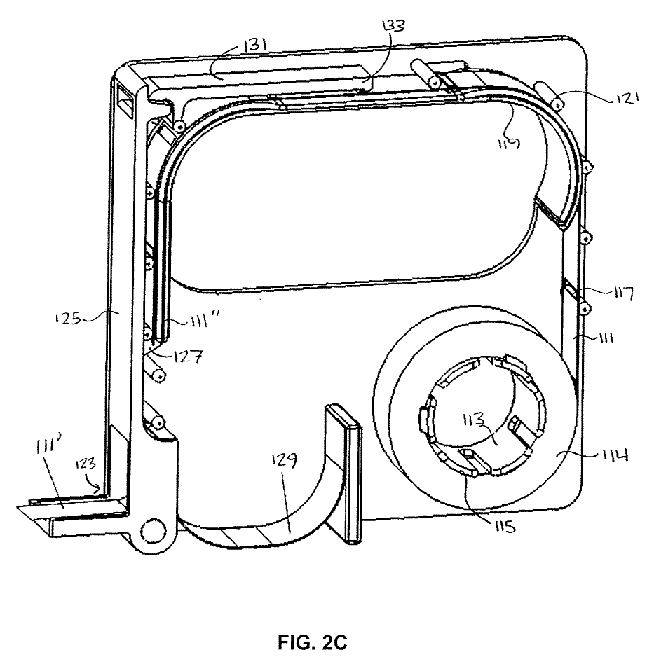

Referring to FIGS. 2A-2C, alternate embodiments of an article dispenser 102 are shown. In the embodiments shown, a menu board station 100 is configured such that a plurality of article dispensers 102 are provided and each is associated with one of the plurality of food items for which information is displayed on the menu board station 100. The article dispensed by the dispenser 102 may be, for example, a token or a ticket.

FIG. 2A shows an embodiment of the article dispenser 102 wherein the article dispensed is a token 110. In the embodiment shown, the article dispenser 102 includes a housing 116 in which a dispensing mechanism 109 is pivotally mounted. Information about the food item, for example, text description 104 and price 106, may be displayed on a display portion 108 of the menu board station 100 adjacent to the dispensing mechanism 109. In some embodiments, the information about the food item displayed on the display portion 108 of the menu board station 100 may be displayed adjacent to a plurality of dispensing mechanisms 109. In some embodiments (not shown) the information about the food item may be displayed on the front face 107 of the dispensing mechanism 109.

In the embodiment shown, a receiving space 105 is located in the housing 116 behind the dispensing mechanism 109. The dispensing mechanism 109 stores a token stack 118 and is biased into a forward position by a resilient member 103. An ejecting member 120 is positioned behind the lowermost token 110 in the token stack 118. A consumer can dispense the lowermost token 110 by pushing on the front face 107 of dispensing mechanism 109. The force pivots the dispensing mechanism 109 against the resilient member 103. The token stack 118 moves into the receiving space 105, except for the lowermost token 110, which is ejected by the ejecting member 120 through a token outlet 112 in the dispensing mechanism 109. When the consumer pulls his/her hand away from the dispensing mechanism 109, the resilient member 103 pivots the dispensing mechanism back into its resting position.

In an alternate embodiment as shown in FIGS. 2B and 2C, the article dispenser 102 may be configured to dispense a ticket 111. In the embodiment shown, the article dispenser 102 includes a reel 113 onto which a roll of tickets 114 is mounted. In alternate embodiments, the tickets may be, for example, configured in a stack rather than a roll. The tickets in the roll are connected to each other at the ends thereof, and a chap 117 is positioned between each of the tickets in the roll. In the embodiment shown, the chap includes a slot or void between each ticket; however, in alternate embodiments, the chap may be otherwise configured. The reel may include a plurality of lips 115 for securing the roll of tickets on the reel.

In the embodiment shown, the tickets of the roll are fed upwardly between a shelf 119 and a plurality of pegs 121. The tickets are then fed laterally and downwardly. The last ticket in the roll 111′ (i.e. the ticket that is to be dispensed next) is positioned adjacent to a dispensing slot 123. In the embodiment shown, the dispensing slot 123 is integral with a key 125. However, in alternate embodiments, the key 125 and the dispensing slot 123 may not be connected.

The key 125 extends upwardly from the dispensing slot 123, and includes a cutting member or pin 127. The pin 127 is positioned to be aligned with the chap 117′ adjacent the next ticket 111′ to be dispensed by the dispenser. In the rest position, as shown in FIG. 2A, the key 125 is biased away from the tickets 110, such that the pin 127 does not contact the chap 117. In the embodiment shown, the key is biased away from the tickets 111 by a leaf spring 129. However, in alternate embodiments, any other suitable type of resilient element may be used.

In the embodiment shown, the upper end of the key 125 is pivotally coupled to an arm 131. The pivotal coupling is provided by an axle on the upper end of the key, around which a portion of the arm extends. The arm 131 extends laterally inwardly from the upper end of the key 125. The end of the arm distal to the key 125 is provided with a hook 133. The hook 133 is sized to fit into the chaps 117 between the tickets 111.

In the embodiment shown, in order to dispense a ticket 111 from the article dispenser 102, the key 125 of the dispenser is pushed inwardly by a user to an activated position as shown in FIG. 2C. The pin 127 on the key 125 cuts the last ticket 111′ in the roll at the chap 117′ adjacent thereto. The severed ticket 111′ then falls downwardly into the dispensing slot 123 such that it may be received by a user. Simultaneously, when the key 125 is pushed, the hook 133 of arm 131 is moved laterally across the tickets 111 on the shelf 119 until the hook 133 engages a chap 117. When the key 125 is released by the user, the spring 129 forces the key 125 back away from the tickets 111, and the key 125 pulls the arm 131 laterally outwardly. The hook 133 of the arm, which has engaged a chap 117, pulls the tickets 111 forwardly such that a new ticket 111″ is positioned adjacent to the dispensing slot 123.

In some embodiments, the restaurant operator may periodically refill the articles in the article dispenser (e.g. the roll of tickets 114, or the tokens in the stack 118). In other embodiments, the articles may be refilled via an automated means, for example, an automatic stacker linked to a token receiving station 136.

The article dispenser 102 may also be operably linked to a monitoring system (not shown). The monitoring system may be a computing device such as a personal computer, laptop, personal data assistant, cellular telephone or any other type of computing device. The monitoring system may track the number of articles 110 output by the article dispenser 102. The monitoring system may also track the number of articles 110 added to the article dispenser 102, or the number of articles in the token stack 118 or the ticket roll 114. The monitoring system may therefore permit the restaurant operator to track the number of articles currently located in the articles dispenser 102. The monitoring system may also permit the restaurant operator to track the number of articles 110 output for a particular food item. This can permit the restaurant operator to track the sales or specific food items associated with the article dispenser 102.

In some embodiments as shown in FIGS. 1B and 2A, the article dispenser 102 may also include a status indicator 124. The status indicator may be any sort of indicating device. For example, the status indicator 124 may be a light, LED, LCD, a textual message, or a flashing light indicator. The status indicator 124 is adapted to toggle between an active condition and an inactive condition. When the status indicator is in an active condition, the article dispenser 102 can output articles 110 associated with a displayed food item. When the status indicator is in an inactive condition, the article dispenser 102 is prevented from dispensing, or is unable to dispense, articles 110 associated with a displayed food item. For example, the status indicator 124 may communicate an inactive condition to a consumer by being illuminated, thus notifying the consumer that there are no articles left in that article dispenser 102, or that the associated food item is sold out.

The condition of the status indicator 124 may be controlled remotely. For example, the restaurant operator may change the status indicator 124 to indicate an inactive condition, when, for example, the article dispenser 102 has run out of articles 110, or when the fast-food restaurant has run out of ingredients necessary to make the food item associated with that article dispenser 102. The restaurant operator can remotely toggle the status indicator between an active and inactive condition by activating a switch, using a remote control or using a wireless device such as, for example, Bluetooth™ technology. In other embodiments, the restaurant operator may toggle the condition of the status indicator between an active and inactive condition by manually changing the status indicator 124 located on the article dispenser 102. In other embodiments, the status indicator 124 may be adapted to indicate the status of the menu board station 100, and not to the article dispenser 102. In yet other embodiments, the status indicator 124 may be adapted to both the menu board station 100 and the article dispenser 102.

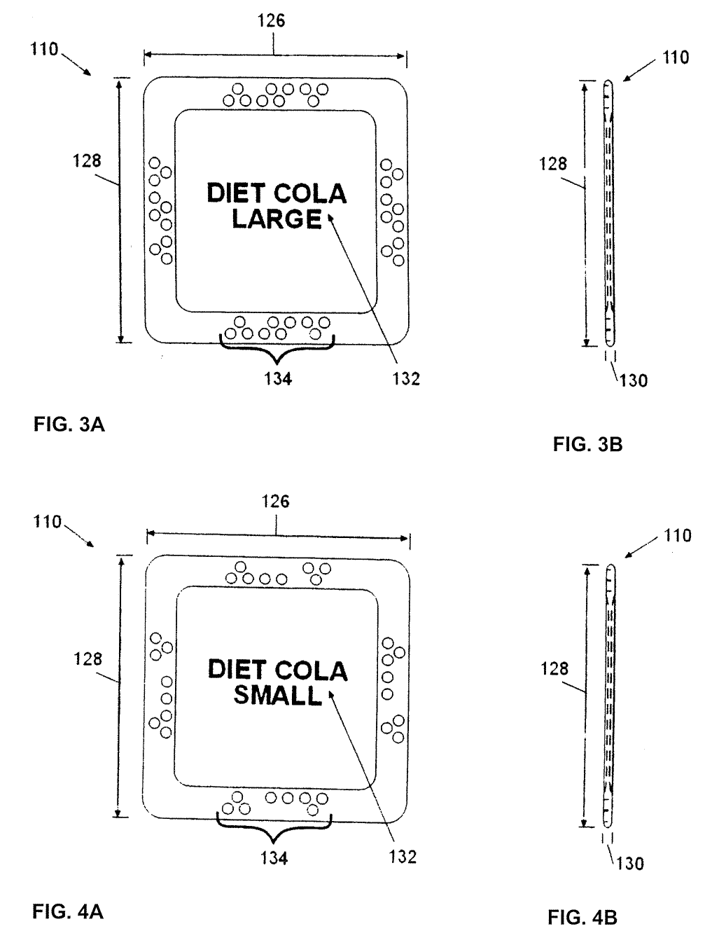

Referring to FIGS. 3A-5B, various embodiments of an article dispensed by article dispenser 102 are shown.

In the embodiments of FIGS. 3A, 3B, 4A, and 4B, the article is a token 110 dispensed by the article dispenser shown in FIG. 2A. The token 110 may have a square planar shape. The token 110 may have a length 126, a width 128, and a thickness 130. The token 110 may have any suitable thickness 130, and preferably, the thickness 130 may vary from a few millimeters to a few centimeters. Preferably, the tokens are large enough for a consumer to easily handle them. In one embodiment, the tokens have a length 126 of 30 mm, a width 128 of 30 mm, and a thickness 130 of 3 mm. The token 110 may be made of any suitable material such as plastic, metal, or cardboard.

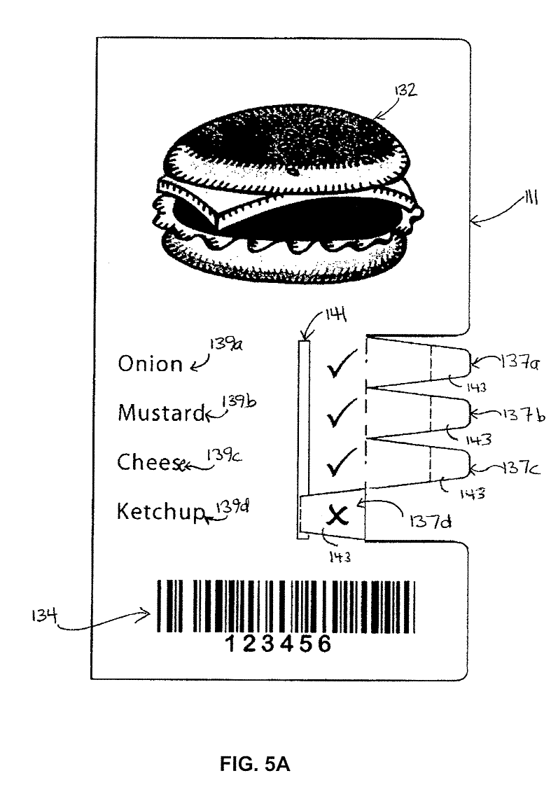

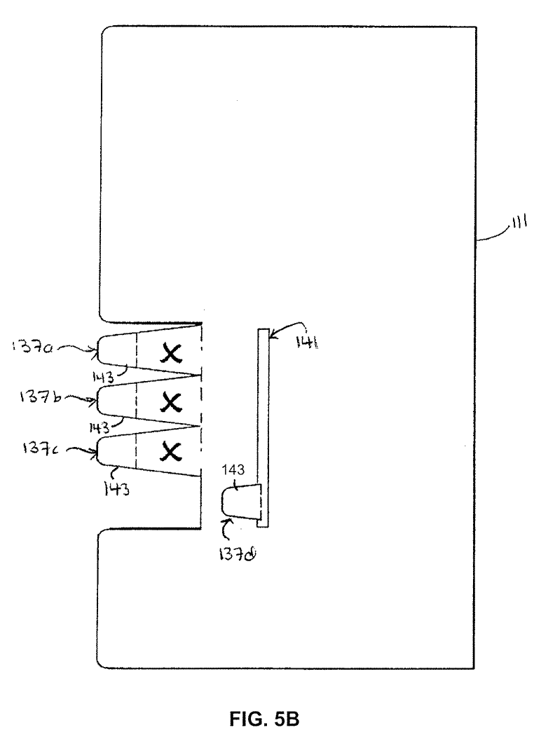

FIGS. 5A-5B illustrate an embodiment in which the article is a ticket 111. The ticket may include a paper sheet of any suitable shape, such as rectangular, square, or polygonal. The ticket 111 may be of any suitable size, such as between about 20 mm and 70 mm in length, and between about 20 mm and 70 mm in width. In some embodiments, the ticket 111 is made from a relatively stiff type of paper such as cardstock.

Referring still to FIGS. 3A-5B, the article 110 may also include identifying data 132. The identifying data 132 typically corresponds to one of the plurality of food items. Typically, the identifying data 132 corresponds to one of the plurality of food items that was displayed on the menu board station 100 and/or on the display portion 108 of the menu board station 100 adjacent to the article dispenser 102. The identifying data 132 shown in FIG. 5A is a picture representation of the corresponding food item, but embossed Braille text of the corresponding food item, or any other suitable means of identifying the corresponding food item to the consumer, could also be displayed.

In addition, the identifying data 132 on article 110 may describe a food item combination. In one embodiment, the articles 110 may be classified into groups corresponding to food item categories. For example, the articles 110 may be color coded (red for beverages, blue for sandwiches, yellow for desserts, etc.). In another example, shapes of the articles 110 may be used to differentiate between categories. For example, the articles 110 associated with a beverage group may have a rectangular shape, articles 110 associated with sandwiches may have a triangular shape, and articles 110 associated with desserts may have an octagonal shape.

In addition, machine-readable data 134 may also be provided on the articles 110. The machine-readable data may correspond to the identifying data 132 or may include more or less information. In some embodiments, the machine-readable data 134 is readable by the article receiving station 136 (shown in FIG. 1C).

In embodiments wherein the article is a token, the machine-readable data 134 may include an RFID transponder, magnetic storage medium, a machine-readable metal composition, a machine readable configuration of holes, or a bar code. In these embodiments, the token receiving station is correspondingly adapted to read machine-readable data 134 stored the token 110.

In the embodiment illustrated in FIGS. 3A, 3B, 4A, and 4B, the holes including the machine-readable data 134 on the token 110, are placed on all four edges of the token 110, such that no matter which direction the token 110 is inserted into the token receiving station 136, the token receiving station can read the machine-readable data 134. In other embodiments, the holes may be punched on only a single edge of the token 110, or on two or three of the four edges.

In embodiments wherein the article is a ticket 111, as illustrated in FIGS. 5A and 5B, the machine readable data 134 may include a machine readable configuration of holes or a bar code.

Additionally, in embodiments wherein the article is a ticket 111, the ticket 111 may include one or more machine readable foldable flaps 137. The foldable flaps 137 may be folded by a consumer after the ticket 110 is received in order to specify additional information about the food item. For example, in the embodiment shown, each ticket 111 includes four flaps 137a-d, each of which is associated with a predetermined property 139a-d for the food item. For example, in the embodiment shown, each flap is associated with a particular condiment for a hamburger. In alternate embodiments, the flaps may be associated with a cooking temperature for a meat product, toppings for a dessert, or flavors for a drink. Each flap 137 has a folded configuration and an unfolded configuration. Each of the configurations is associated with a desired presence or absence of the predetermined property for the food item. For example, in the embodiment shown, flaps 137a to 137c are in the unfolded configuration indicating a desired presence of onion, mustard, and cheese, respectively, on the hamburger. Flap 137d is in the folded configuration indicating a desired absence of ketchup on the hamburger. In the embodiment shown, the ticket additionally includes a slot 141 into which a foldable tab 143 of each flap is insertable for securing the flaps 137 in the folded configuration.

In other embodiments, the article 110 may include a picture or text representation of a prize substituted for the identifying data 132. For example, if the restaurant is having a promotional campaign and giving away prizes, a prize winning article 110 can be dispensed at random from an article dispenser 102 to a consumer. In this embodiment, a consumer selects a food item and receives an article 110 from the article dispenser 102. However, instead of receiving an article 110 for the selected food item, the consumer receives an article 110 for a prize such as free lunch for a week. In other embodiments, combinations of articles 110 may be required to win the prize.

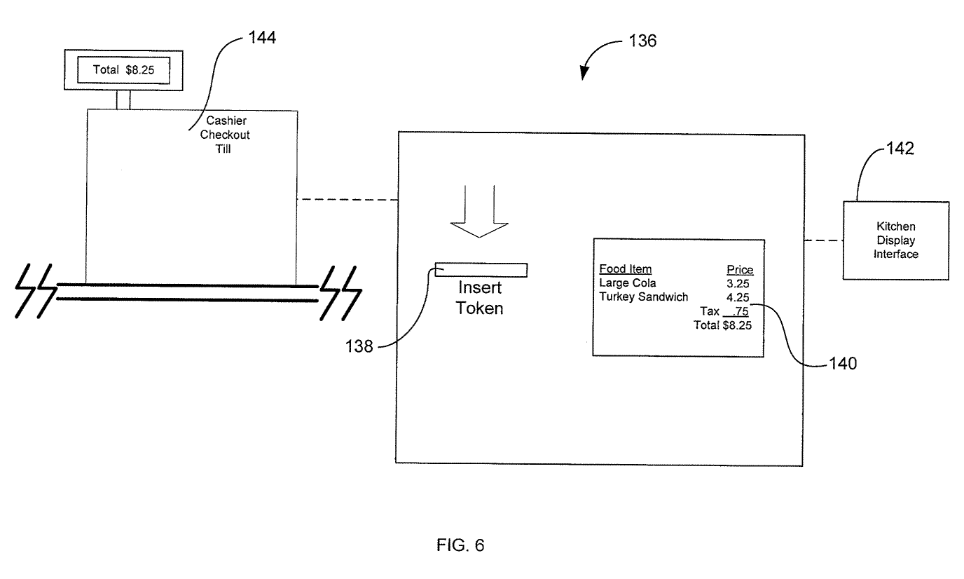

Referring now to FIGS. 1C and 6, an article receiving station 136 is shown. In the embodiment shown, the article receiving station 136 is configured for receiving a token. The article receiving station 136 includes a token intake 138 (such as a slot), a display 140, a token identification device (not shown), and a token sorting device 146. In an alternate embodiment (not shown), the article receiving station 136 may be configured to receive a ticket, and may include a ticket intake, a display, and a ticket identification device. In such an embodiment, a sorting device may not be required, as the tickets may be disposed of after use.

In some embodiments, the article receiving station 136 is operably linked to a kitchen display interface 142 located in a food preparation area of the restaurant. Alternatively or additionally, the article receiving station 136 may also be operably linked to a point-of-sale terminal or cash register 144.

The consumer can insert an article 110 or a plurality of articles 110 into the article intake 138 of the article receiving station 136. In some embodiments, the article receiving station 136 may include a plurality of article intakes 138 such that a plurality of consumers can enter a plurality of articles 110 simultaneously into the article receiving station 136.

Preferably, the article receiving station 136 includes any suitable article identification device for reading the machine-readable data 134 on the article. For example, the article receiving station 136 may include a light detector that can read the holes including the machine-readable data 134 on a token 110 or a ticket 111. In other embodiments, depending on the type of article used, the article receiving station 136 may include a specialized metal detector, an RFID reader, a bar code reader, or any other suitable identification device corresponding to the data storage medium of the machine-readable data 134. In addition, the article receiving station may include a reader for reading the predetermined property and configuration associated with the foldable flaps on a ticket.

The article receiving station 136, upon identifying the machine-readable data 134, displays the data on the display 140. The display 140 may be an LED, LCD, Plasma, CRT monitor or any other suitable display. The identifying data displayed on the display 140 may include a text description as well as the price of the food item that corresponds to the article inserted into the article receiving station 136. In other embodiments, the display 140 may also display a picture representation of the food item corresponding to the machine-readable data 134 of the article 110. The display 140 may display the machine-readable data 134 for a plurality of articles 110 inserted into the article receiving device 136. For example, the display 140 may display a text list of the plurality of food items corresponding to the articles 110 input into the article receiving station 136 by the consumer.

In other embodiments, the article receiving station 136 may include a plurality of displays 140 such that the machine-readable data 134 for each article is displayed on a corresponding display 140. This can permit a plurality of consumers to simultaneously interact with the article receiving station 136. In other embodiments, the article receiving station 136 may be configured such that one display 140 may display information from two or more tokens 110.

In one embodiment, the article receiving station 136 may also calculate a total price for the plurality of food items corresponding to the plurality of articles 110 inserted into the article receiving station 136. If a consumer places a plurality of articles 110 into the article intake 138, the food items associated with these articles 110 comprise an “order.” The amount payable for the order, which is a sum of the price of the food items associated with the inserted articles 110, together with any applicable taxes or other charges, may also be displayed on the display 140 of the article receiving station 136. In one embodiment, the article receiving station 136 may include a computing device (not shown) that is capable of calculating the amount payable for the order.

Alternatively, the price of one or more food items may be stored in the article receiving station 136, and the price is displayed on the display 140 of the article receiving station 136. The restaurant operator may change the price of a particular food item by changing the price stored in the article receiving station 136. This simplifies adjusting the price of the various food items sold by the restaurant. In some embodiments, changing the price of a food item in the article receiving station 136 also simultaneously changes the price 106 displayed on the menu board station 100 adjacent to the article dispenser 102 for the corresponding item.

In some embodiments, the machine-readable data 134 may also be communicated to and displayed on a kitchen display 142. The kitchen display 142 is typically located in the food preparation facilities 148 of the restaurant. For example, in a fast food restaurant, if an article 110 corresponding to a turkey sandwich combo is placed into the article receiving station 136, the kitchen display 142 located, for example, near the area of the restaurant where the turkey sandwiches are prepared (the sandwich preparation station), may display that a turkey sandwich has been ordered. The employee preparing the turkey sandwich in the food preparation area 148 is then made aware that they need to prepare a turkey sandwich. Therefore, the turkey sandwich may be prepared in a timely fashion.

The article receiving station 136 may be operably linked to the kitchen display 142 via any suitable means, such as a wire or cable, or via wireless communication, such as Bluetooth™. In some embodiments, the kitchen display 142 may be an LCD, LED, or CRT monitor display, or any other types of display. In other embodiments, the kitchen display 142 may be a printed piece of paper, an audio signal, or an indication light located on a menu visible in the food preparation area.

In some embodiments, the article receiving station 136 may also be operably linked to the cash register 144. This may permit the token receiving station 136 to electronically communicate to the cash register the amount payable by the consumer for the order. The employee can then collect the amount payable from the consumer and deliver the food items ordered to the consumer.

In other embodiments, the consumer may be required to pay for the food order at the article receiving station 136. For example, the consumer may, after placing all of the desired articles 110 into the article receiving station 136, pay the amount payable by placing the consumer's method of payment into the article receiving station 136. In this embodiment, the article receiving station 136 may accept any suitable method of payment such as cash, credit cards, or debit cards. In the case of a cash transaction, the receiving station 136 may then provide any change due to the consumer and print a receipt for the transaction for the consumer.

In one embodiment, the receipt may include an order number corresponding to the order. A restaurant employee may cross reference the order number printed on the receipt with the ordered food items and deliver the ordered food items to the consumer.

The article receiving station 136 may also store information about the articles 110 inserted into the article receiving station 136 in order to permit statistical tracking of food items ordered. For example, the article receiving station 136 may include a computing device (not shown) which monitors and stores any desired information associated with the articles 110. The machine-readable data 134 on the article 110 may be communicated and stored by the computing device.

In some embodiments, the article receiving station 136 may also include an article sorting device (not shown) and article containers (not shown). The article sorting device may be particularly useful in embodiments wherein the article is reusable such as when the article is a token. For example, once a consumer places the token 110 into the token input 138, and the token receiving station 136 has collected the machine-readable data 134, the token may be sorted into a token container which corresponds with tokens 110 associated with the same food item. For example, the turkey sandwich combo tokens 110 are sorted by the token sorting device and placed into the appropriate token container that contains exclusively turkey sandwich combo tokens 110. The restaurant employee may then easily remove the tokens 110 accumulated in the token receiving station 136 associated with the turkey sandwich combo. The restaurant employee may then remove the accumulated turkey combo tokens 110 from the token receiving station 136 and place them into the appropriate associated turkey sandwich combo token dispenser 102.

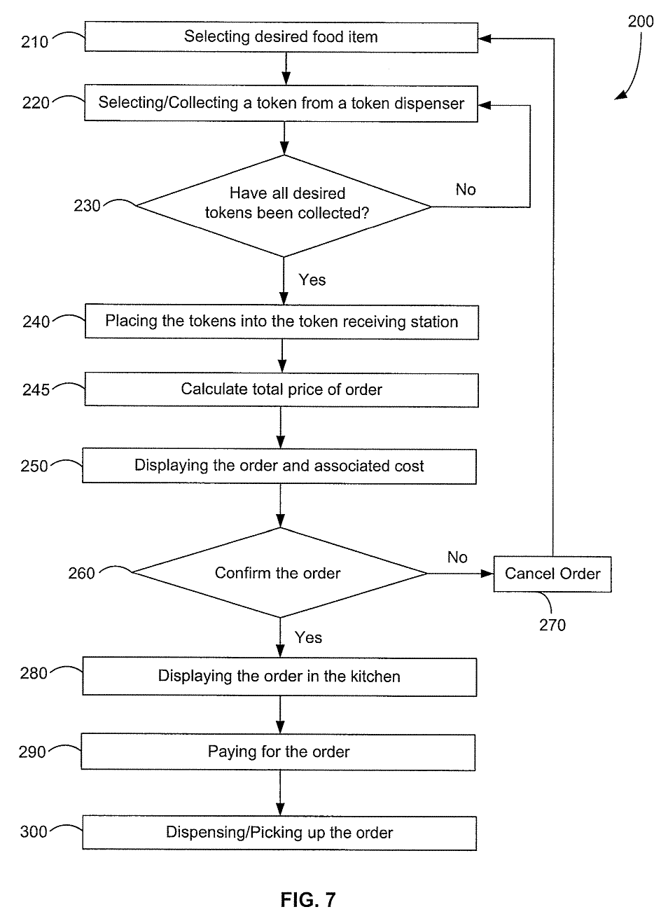

Reference is now made to FIG. 7, which illustrates a flow chart of an embodiment of method 200 of ordering a food item according to an aspect of the present disclosure.

At step 210, the consumer selects a desired food item or items from the menu board station 100. Preferably, the menu board station 100 is located such that it can simultaneously be observed by a plurality of consumers. As the consumers are not in a line-up, there is less pressure on the consumers to quickly choose their desired food items. The consumers are therefore free to observe and peruse all of the food items listed on the menu board station 100. In addition, because the menu board station 100 typically includes a plurality of article dispensers 102 associated with one or a combination of food items, a number of consumers can simultaneously interact with the menu board station 100. For example, a plurality of consumers can simultaneously be pressing the front face 107 of the dispensing mechanism 109 of the article dispensers 102, thus simultaneously receiving articles 110.

At step 220, the consumer receives an article from an article dispenser 102 associated with one of the food items selected at step 210. For example, the consumer may push a button on a token or ticket dispenser.

At decision diamond 230, the consumer may return to step 220 if he/she desires to collect articles for additional food items or proceed to step 240 if his/her order is complete.

At step 240, the consumer places all of the collected articles 110 into the intake 138 of article receiving station 136 in order to place an order. The article receiving station may then identify each of the food items in the order (not shown), for example, by reading machine-readable data on the article.

The total price of the order may then be calculated at step 245. At step 250, the article receiving station 136 may display the food items in the order and the price of the corresponding food items on the display 140. The total amount payable may also be displayed.

At decision diamond 260, receiving station 136 may display a message to the consumer to confirm his/her order. The confirmation is desirable to ensure that the correct food items have been ordered and/or that the total amount payable is acceptable to the consumer.

Confirmation of the order may be carried out in any number of ways such as asking the consumer to press a confirmation button (not shown) on the article receiving station 136 or to insert a confirmatory article (not shown), or to ask the cashier supervising the article receiving station 136 to confirm the order.

If the order is not confirmed by the consumer, the order may be cancelled by the consumer at step 270. If the consumer cancels the order, the consumer can leave the restaurant or return to step 210 to select different food items.

If the consumer confirms the order, the method may move to step 280, wherein the order may be displayed on the kitchen display 142 in the food preparation area 148 of the restaurant. This permits the food preparation staff to prepare the food items in the order in a timely fashion.

At step 290, the consumer may pay for the order. The amount payable may be calculated by the article receiving station 136. As discussed above, the consumer may pay directly at the article receiving station 136 or, alternatively, at the cash register 144. In some embodiments, the cashier may manually enter prices of the food items into the cash register 144 and then request payment from the consumer.

At step 300, the restaurant operator may dispense the food items in the order to the consumer. In some embodiments, the consumer picks up the order. In other embodiments, an automated method of dispensing the order may be used. For example, the food preparation staff of the restaurant places the food items in the order into a selectively accessible chamber (not shown), and the consumer then picks up the order from the selectively accessible chamber.

Once the consumer has picked up the order, he/she can then proceed to a seat in the restaurant, or to their home or car to enjoy their food.

One advantage of the present disclosure may be the increased efficiency of the ordering system, for example, an increase in the number of orders processed per unit time. In a typical cashier-based ordering system common in fast food restaurants, the orders per unit of time that can be processed may be expressed as:

Number of orders/unit of time=number of cashiers/(time for the consumer to select a food item(s)+time for the consumer to place an order+time for the consumer to make a payment for the order).

Another example method of ordering a fast food item is a kiosk ordering system. In a kiosk ordering system, the cashier is essentially replaced by a kiosk machine with which the consumer interacts to select and pay for the desired food items. In the kiosk ordering system, the number of orders per unit time that can be processed may be expressed as:

Number of orders/unit time=number of kiosks/(time for the consumer to select a food item(s)+time for the consumer to place an order+time for the consumer to make a payment for the order).

In the above embodiments of the article-based ordering system, the number of orders per unit time that can be processed may be expressed as:

Number of orders/unit time=number of article receiving stations/time for the consumer to make a payment for the order.

As seen in the equations listed above, the article-based ordering system according to embodiments of the present disclosure can typically process more orders per unit time than the cashier-based and kiosk-based ordering systems. One reason for the increased efficiency is because the article-based ordering system does not require time for the consumer to select a food item(s) and time for the consumer to place an order. Typically, in the article-based ordering system, the time for the consumer to select a food item(s) and the time for the consumer to place an order are completed simultaneously by a plurality of consumers who can select their desired food item(s) from the menu board station 100 and the associated article dispensers 102.

Another advantage of the embodiments of the present disclosure may be reduced consumer waiting time to place an order. For example, in a typical cashier-based ordering system common in fast food restaurants, the consumer's waiting time to place an order may be expressed as:

Consumer's waiting time to place an order=the number of consumers in line×(the time required for the consumer to select a food item(s)+the time required by the consumer to place an order+the time required by a consumer to make a payment for the order).

In the kiosk ordering system described above, the consumer's waiting time to place an order may be expressed as:

Consumer's waiting time to place an order=the number of consumers in line×(the time required for the consumer to select a food item(s)+the time required by the consumer to place an order+the time required by a consumer to make a payment for the order)/number of kiosks.

In the token-based ordering system according to embodiments of the disclosure described above, the consumer's waiting time may be expressed as:

Consumer's waiting time to place an order=the number of consumers in line×(the time required by a consumer to make a payment for the order)/the number of article receiving stations.

As seen in the equations listed above, the above embodiments of the article-based ordering system typically have a reduced consumer waiting time to place an order as compared to the cashier-based ordering system and the kiosk-based ordering system. One reason for the reduced waiting time is because the above embodiments of the article-based ordering system do not require time for the consumer to select a food item(s), and time for the consumer to place an order. Typically, in the above embodiments of the article-based ordering system, the time for the consumer to select a food item(s) and the time for the consumer to place an order are completed simultaneously by a plurality of consumers who can select their desired food item(s) from the menu board station 100 and the associated article dispensers 102.

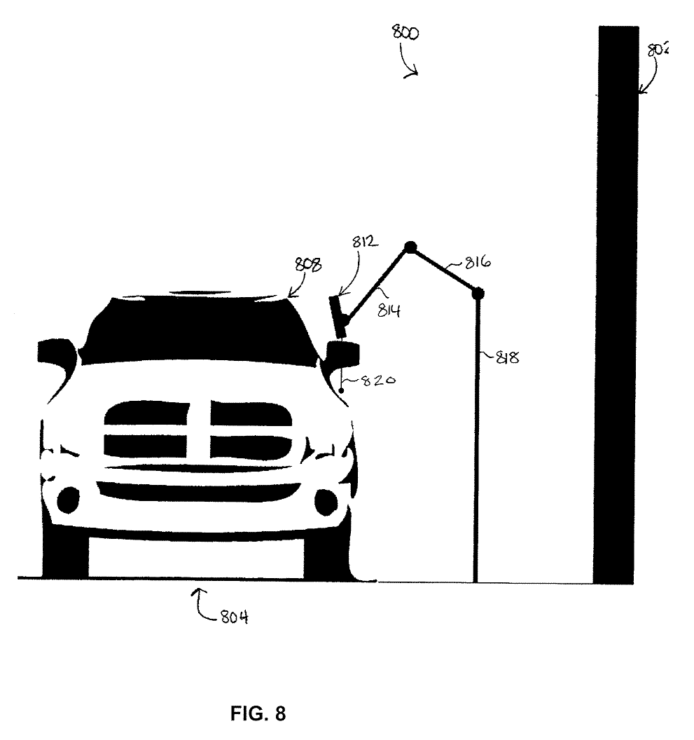

An alternate embodiment of a food ordering system 800 and method 1100 is shown in FIGS. 8-11. Food ordering system 800 may be particularly useful in drive-through type restaurants. However, it may be used in other venues such as inside a restaurant.

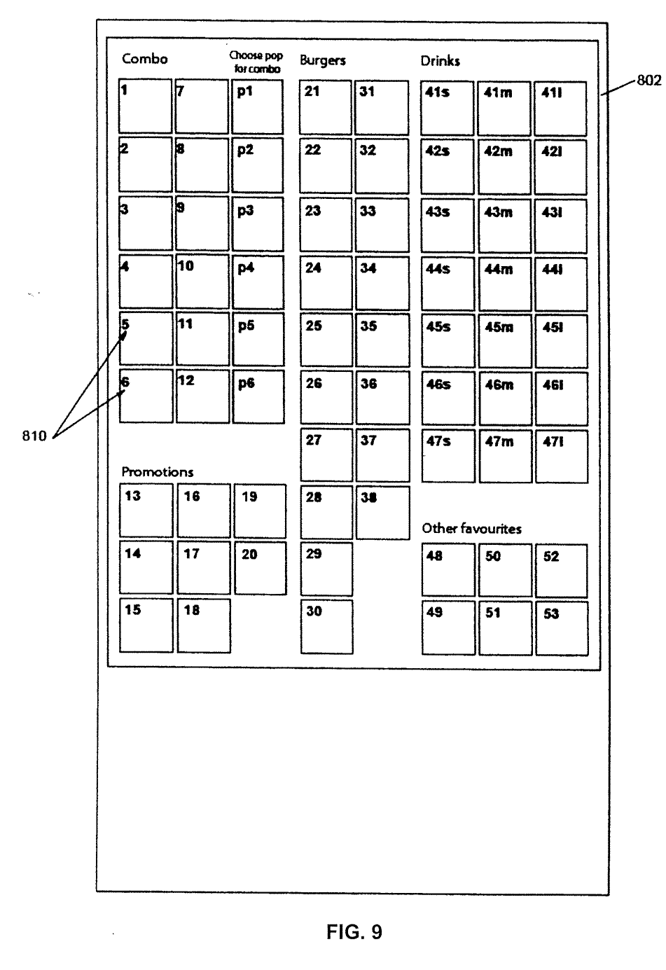

Referring to FIGS. 8 and 9, food ordering system 800 includes a menu board station 802 displaying information about a plurality of food items. The menu board station 802 may be positioned adjacent to a driveway 804 of a drive-through such that a driver may drive a vehicle 808 sufficiently close to menu board station 802 to view the menu board.

Menu board station 802 may display various types information about each food item, in various classifications or groups, and may be selectively altered as described hereinabove with respect to menu board station 100.

Included in the displayed information about each food item is an identifier 810 associated with each food item. The identifier may be a number, a symbol, or a word. For example, a hamburger combo may be associated with the number 1, and a cheeseburger combo may be associated with the number 2.

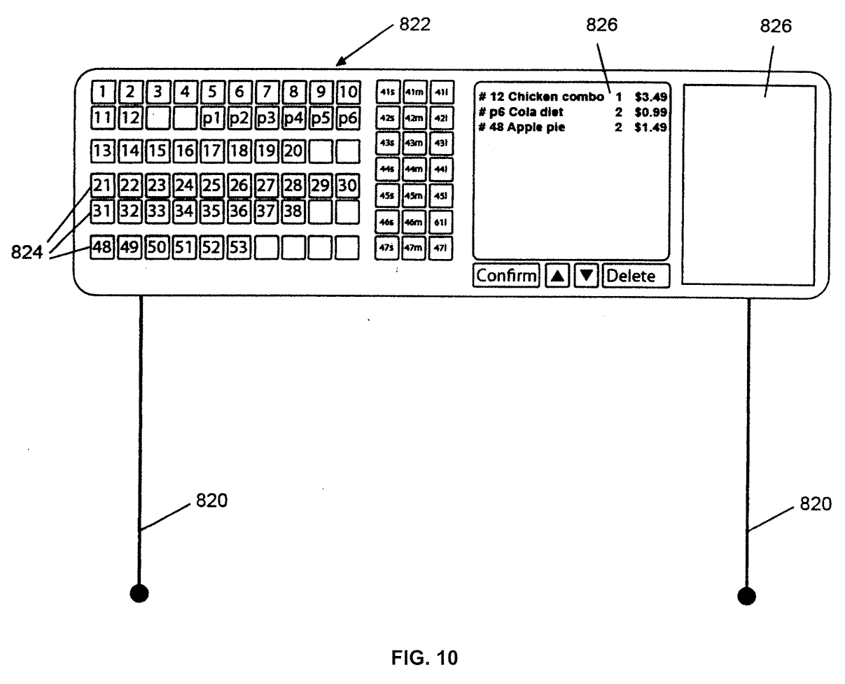

Referring to FIGS. 8 and 10, an ordering panel 812 is positioned proximate to the menu board such that a user may access the ordering panel from their vehicle 808 while viewing the menu board station 802. For example, the ordering panel 812 may be positioned between the menu board station 802 and the driveway 804 within an arms reach of the driveway 804.

In some embodiments, the ordering panel 812 is movably mounted such that a user may move the ordering panel 812 to a comfortable position for use. For example, a user in a larger car may wish to move the ordering panel 812 to a higher position, and a user in a smaller car may wish to move the ordering panel 812 to a lower position.

In the embodiment shown, the ordering panel 812 is movably mounted via a plurality of pivotal arms. The ordering panel 812 is pivotally mounted to a first arm 814, which is pivotally mounted to a second arm 816, which is pivotally mounted to a stand 818. The ordering panel 812 further includes handles 820 which a consumer may grip in order to reposition the ordering panel 812.

The ordering panel 812 includes a user interface for the consumer to place an order. The user interface is configured such that the consumer may input the identifier associated with a selected food item. For example, the user interface may include a keyboard 822 or a touch screen (not shown). The keys 824 on the keyboard may be labeled with the identifiers shown on the menu board, as well as various other labels such as an “enter” key, a “delete” key, and a “confirm” key. Accordingly, if a user wishes to place an order for a hamburger combo and a cheeseburger combo, the user may push the key labeled “1” followed by the “enter” key, the key labeled “2” followed by the “enter” key, and the “confirm” key.

The ordering panel may additionally include a display 826, which displays various information about the order being placed. For example, the display 826 may show the name of each food item being ordered, the identifier 810 of each food item being ordered, the cost of each food item being ordered, the tax associated with the order, and the total cost of the order. The display may be configured similarly to display 140 described hereinabove.

The ordering panel may additionally include various optional features such as a microphone and a speaker for communicating with restaurant staff and/or a “help” button.

The ordering panel 812 is capable of communication with a kitchen interface (not shown) which receives the order. The ordering panel and the kitchen interface may communicate in a variety of ways such as by a wire or cable, or by wireless communication, such as by Bluetooth™. The kitchen interface may include, for example, a display such as display 142 described hereinabove for displaying the order to the kitchen staff.

The food ordering system may additionally include a paying station 826 proximate to the ordering panel 812, such that a user may access the paying station 826 from their vehicle while viewing the menu board 802 and ordering panel 810. In the embodiment shown, the paying station 826 is integral with the ordering panel 810.

The paying station 826 may be linked with the ordering panel such that when an order is placed, the cost of the order is transmitted to the paying station. The paying station may be configured to receive, for example, cash, credit cards, debit cards, or coupons, and to provide change and a receipt.

In alternate embodiments, the ordering panel may be operably linked with a cash register within the restaurant.

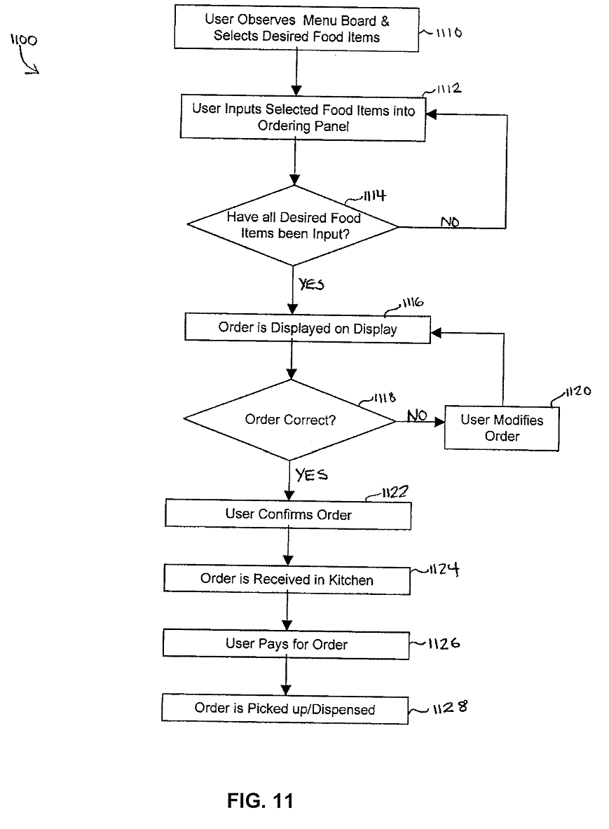

An embodiment of a method of using food ordering system 800 is shown in FIG. 11. At step 1110, a user observes or views the menu board in order to select any desired food items. For example, the user may drive a vehicle to a position adjacent the menu board, stop the vehicle, and view the menu board. When the user has selected the desired food items to be ordered, the method may proceed to step 1112.

At step 1112, the user may input the selected food items into the ordering panel to place an order. For example, if the user wishes to order a hamburger, and the menu board shows the identifier “1” associated with a hamburger, the user may enter the number “1” into the ordering panel. In order to enter the number “1,” the user may, for example, push a key with the number “1” on it, or touch a portion of a touch screen with the number “1” on it. Depending on the configuration of the ordering panel, the user may optionally press an “enter” key after entering the identifier.

At decision diamond 1114, a decision is made by the user as to whether all desired food items have been input into the ordering panel. If the user wishes to order additional items, the user may return to step 1112. If all desired food items have been ordered, the method may proceed to step 1116.

At step 1116, the order is displayed on a display of the ordering system. Additionally, the cost of each item, the cost of the total order, and any additional information may be displayed.

At decision diamond 1118, the user may decide whether the order displayed on the display is correct. If the displayed order is incorrect, the user may proceed to step 1120 wherein the order may be modified. For example, the user may push a “delete” key on the ordering panel to delete a food item, or the user may push additional keys on the ordering panel to add additional food items to the order. The method then returns to step 1116 where the revised order is displayed on the display of the ordering panel.

If the displayed order is correct, the method may proceed to step 1122, wherein the order is confirmed by the user. To confirm the order, the user may, for example, press a “confirm” key on the ordering panel.

When the user has confirmed the order, the method may proceed to step 1124. At step 1124, the order is received in the kitchen. For example, the order may be displayed on a kitchen display. Accordingly, the kitchen staff may proceed to prepare the order. In the embodiment shown, step 1126 follows step 1124; however, steps 1126 and 1124 may be carried out simultaneously, or step 1126 may precede step 1124. At step 1126, the user may pay for the order. The user may pay for the order by using a paying panel proximate to the ordering panel or, alternately, may proceed to a payment window.

When the order has been prepared and paid for, the method may proceed to step 1128 wherein the order is picked up or dispensed. For example, if the order was paid for proximate to the ordering panel, the driver may drive the vehicle to a pick-up window. Alternately, if the order was paid for at a payment window, the order may be picked up at the payment window.

It will be appreciated that various modifications and alterations of the embodiments noted herein may be made and each is within the scope of the following claims. Features that are described individually with respect to certain embodiments can be variously combined in other embodiments.

1. A food ordering system comprising:
a) a menu board station adapted to display information about a plurality of food items,
b) at least one dispenser associated with at least one of the plurality of food items, the at least one dispenser being adapted to dispense an article including identifying data corresponding to one of the plurality of food items; and
c) an article receiving station adapted to receive the article and identify the identifying data on the article.

2. The food ordering system of claim 1, wherein the article is one of a token or a ticket.

3. The food ordering system of claim 2, wherein the article is a ticket comprising at least one flap, the flap being associated with a predetermined property for the food item, the flap being movable between a folded configuration and an unfolded configuration; the folded configuration being associated with one of a desired presence or a desired absence of the predetermined property for the food item, and the unfolded configuration being associated with the other of the desired presence and the desired absence of the predetermined property for the food item.

4. The food ordering system of claim 3, wherein the predetermined property is a condiment for the food item.

5. The food ordering system of claim 3, wherein the article receiving station is adapted to identify the predetermined property and configuration associated with each flap.

6. The system of claim 1, wherein the dispenser further comprises a status indicator adapted to toggle between an active condition and an inactive condition, wherein the status indicator is adapted to communicate an inactive condition when the article dispenser is prevented from dispensing articles.

7. The system of claim 6, wherein the status indicator is controlled by one or more of remotely and by a wireless device.

8. The system of claim 1, wherein the article receiving station calculates a total price when a plurality of articles are received by the article receiving station and displays the total price.

9. The system of claim 1, wherein the article receiving station is operably linked to a kitchen display interface, wherein the article receiving station transmits the identifying data to the kitchen display interface.

10. The system of claim 1, wherein the information displayed on the menu station comprises one or more of a picture representation of a food item, a textual description of a food item, and embossed Braille text describing the food item.

11. The system of claim 1, wherein the identifying data identified by the receiving station is stored.

12. The system of claim 1, wherein the information displayed on the menu board station can be one or more of selectively altered, and selectively altered remotely, and selectively altered remotely by a wireless device.

13. The system of claim 1, wherein the identifying data of the article comprises one or more of a picture representation of a food item, and a textual description of a food item.

14. The system of claim 1, wherein the identifying data is stored on the article via one or more of a plurality of holes formed in the article, a barcode on the article, an RFID transponder, a readable metal composition, and a magnetic storage medium.

15. The system of claim 1, wherein the menu board station displays information about a plurality of food items, wherein the food items can be classified into a plurality of food item groups, and wherein the tokens are classified into groups corresponding the food item groups.

16. A method of ordering a food item, the method comprising the steps of:
a) selecting a food item displayed on a menu board station;
b) receiving an article associated with the food item from an article dispenser; and
c) placing the article in an article receiving station to place an order.

17. The method of claim 16, further comprising:
d) identifying each of the food items in the order from the articles associated therewith.

18. The method of claim 17, further comprising calculating a price of the order.

19. The method of claim 18, further comprising displaying the price of the order on a display proximate the article receiving station.

20. The method of claim 18, further comprising confirming the order.

21. The method of claim 19, further comprising paying for the order.

22. The method of claim 16, further comprising selecting a second food item from the menu board and receiving a second article associated with the second food item, wherein the first and second articles are placed in the article receiving station to place an order.

23. A food ordering system comprising:
a) a menu board station displaying information about a plurality of food items, the information including at least one identifier associated with each food item;
b) an ordering panel proximate the menu board station and including a user interface for inputting one or more of the identifiers to place an order;
c) a kitchen interface operably linked to the ordering panel for receiving the order.

24. The food ordering system of claim 23, wherein the at least one identifier includes a number associated with each food item.

25. The food ordering system of claim 23, wherein the ordering panel includes a display configured to display one or more of a name of each ordered food item, a cost of each ordered food item, and a total cost of the order.

26. The food ordering system of claim 23, wherein the ordering panel is wirelessly linked to the kitchen display interface.

27. The food ordering system of claim 23, wherein the information further includes one or more of a photo of each food item, name of each food item, and a description of each food item.

28. The food ordering system of claim 23, wherein the information displayed on the menu board can be selectively altered remotely.

29. The food ordering system of claim 23, wherein the food ordering system further comprises a paying station proximate to the ordering panel.

30. The food ordering system of claim 29, wherein the paying station is integral with the ordering panel.

31. The food ordering system of claim 23, wherein the ordering panel comprises one of a touch screen or a keypad.

32. A ticket for a food ordering system, the ticket comprising:
a) at least one flap, the flap being associated with a predetermined property for a food item;
b) the flap being movable between a folded configuration and an unfolded configuration;
c) the folded configuration being associated with one of a desired presence or a desired absence of the predetermined property for the food item; and
d) the unfolded configuration being associated with the other of the desired presence and desired absence of the predetermined property for the food item.

33. The ticket of claim 32, wherein the predetermined property is a condiment and the folded configuration is associated with the desired absence of the condiment.

34. The ticket of claim 32, wherein the predetermined property associated with the flap and the configuration of the flap is machine readable.
